(19) United States
(12) Patent Application Publication
(10) Pub. No.: US 2002/0156606 A1
(43) Pub. Date: Oct. 24, 2002

(54) Digitized thermal functional design of textiles and clothing

(76) Inventors: Yi Li, Kowloon (HK); Edward Newton, Kowloon (HK); Burley Zhong Wang, Kowloon (HK)

Correspondence Address: LEYDIG VOIT & MAYER, LTD, 700 THIRTEENTH ST. NW, SUITE 300, WASHINGTON, DC, 20005-3960, US

(21) Appl. No.: 09/840,462

(22) Filed: Apr. 24, 2001

(51) Int. Cl. G06G 7/48

(52) U.S. Cl. 703/11

(57) ABSTRACT

Visual thermal functional textile clothing designs are created using a programmed computer and advanced computing techniques. The computer is supplied with information from a number of databases relating to human body properties and relating to textile material characteristics. The method is used to generate functional designs that are visually displayed for use by a textile designer or engineer.

### BACKGROUND OF THE INVENTION

1. Field of the Invention

The invention relates to digitized thermal functional design of textiles and clothing.

2. Description of Prior Art

The invention relates more particularly to the development of using computer technology to provide designs and design data for use in preparing and assessing suitable textiles for human apparel taking into account various thermal characteristics of the human body and available textile materials. Objective matching of those characteristics could enable articles of clothing and textiles to be created and designed. In this respect, data has already been amassed about such characteristics but has not been applied comprehensively with digitized modeling of the thermal physiology of the human body and heat and moisture transfer of the material, in a manner that can be practically applied by textile clothing designers, engineers and scientists.

### SUMMARY OF THE INVENTION

It is an object of this invention to overcome this problem.

According to the invention there is provided a method of creating thermal functional designs of textiles and clothing using a computer and visual display monitor controlled by the computer, the method comprising supplying the computer with information from databases relating to thermal physiological characteristics of a human body and thermal characteristics of chosen textile materials for computational simulation of the information, and creating visual images for the monitor showing modules of thermal functional designs.

The database of the human body may comprise human model data for specific body functions, including size and shape.

The database of the garments may comprise clothing patterns data and product specification data.

The database of the human body may comprise thermal property data, including thermo-physiological and thermal comfort data of human body.

The textile materials may comprise thermal property data, including fibres, yarns, fabrics and garments.

### BRIEF DESCRIPTION OF THE DRAWINGS

A method of creating thermal functional designs according to the invention will now be described by way of example with reference to the accompany drawings in which:

FIG. 1 is an overall schematic view of the method;

FIG. 2 is a flow diagram of a structural arrangement of the method; and

FIG. 3 is a flow diagram of a processing arrangement of the method.

### DESCRIPTION OF THE PREFERRED EMBODIMENTS

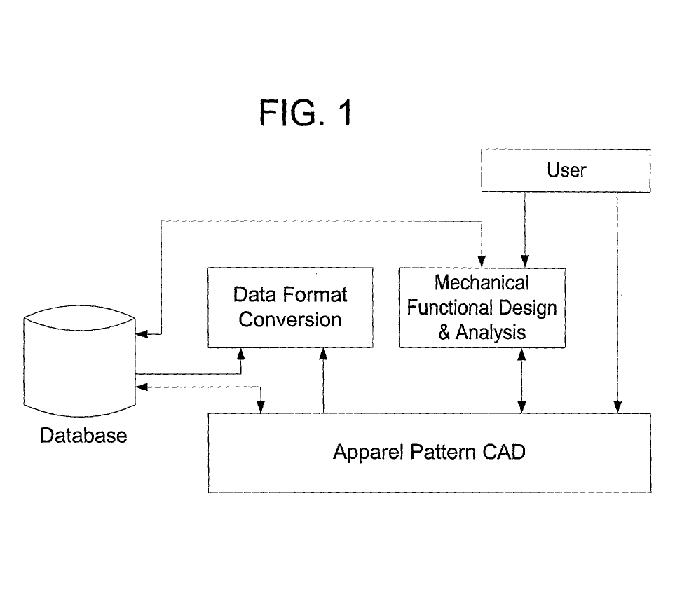

Referring to the drawings, in FIG. 1 a textile designer or engineer (“user”) selects his requirements and inputs to a computer, represented in this Figure as programmed to carry out Data Format Conversion and Thermal Functional Design and Analysis. The computer is also programmed to control an Apparel Pattern CAD function that can be said to represent, in effect, a visual display monitor that is controlled by the computer, to create modules of functional designs.

In use, databases representing thermal and physiological characteristics of a human body and thermal characteristics of textile materials are called-up for supply to the computer. Data is logically matched or manipulated to create the required modules. Such characteristics and properties have been already amassed and established in databases known in the art. An example is set forth in Li, Y., Advanced Computing Technology for Integrated Design of Textiles and Apparel; Ergonomics of Protective Clothing, Proceedings of NOKOBETEF 6 and 1^{st} European Conference on Protective Clothing; Stockholm, Sweden; May 7-10, 2000, which is herein incorporated by reference in its entirety. Such databases relate to human models, patterns of apparel products, human thermo-physiological characteristics, and thermal comfort knowledge. The databases also relate to textile information including thermal properties and structure parameters of clothing materials generally, of different fibres, yarns, fabrics and garments, and of human skin and tissues. Advanced computing technologies developed on the basis of advanced mathematical modelling of the thermo-physiology of the human body and heat and moisture transfer of the clothing materials, are incorporated by the computer to integrate and process the information available from the databases. The information is used to create a number of modules to enable a textile designer or engineer to objectively design apparel and textile articles to serve any number of standard or specialized end-uses.

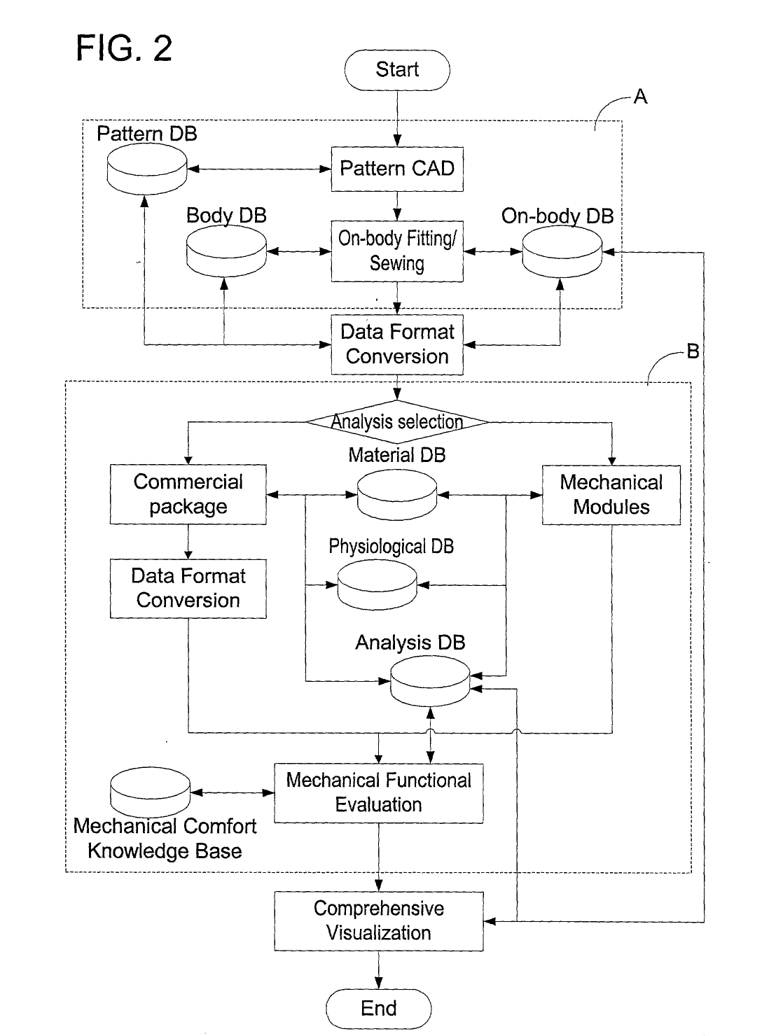

In FIG. 2, the flow chart shows the structural arrangement of the method. In a block A, the thermo-physiological characteristics of a human body are considered together with a chosen pattern of a selected article of clothing. A digitised clothed human body is transformed to specific data format for supply to a block B.

In the block B, computational mathematics using commercially available packages or specially designed software packages with special Data Format Conversion, are used to logically match and compute information from thermal databases relating to the textile materials. A thermal functional evaluation is provided that is compared with data from a Thermal Comfort Knowledge database, which is derived from practical information amassed from knowledge about thermal comfort of apparel. An output is provided to create and display a Comprehensive Visualisation.

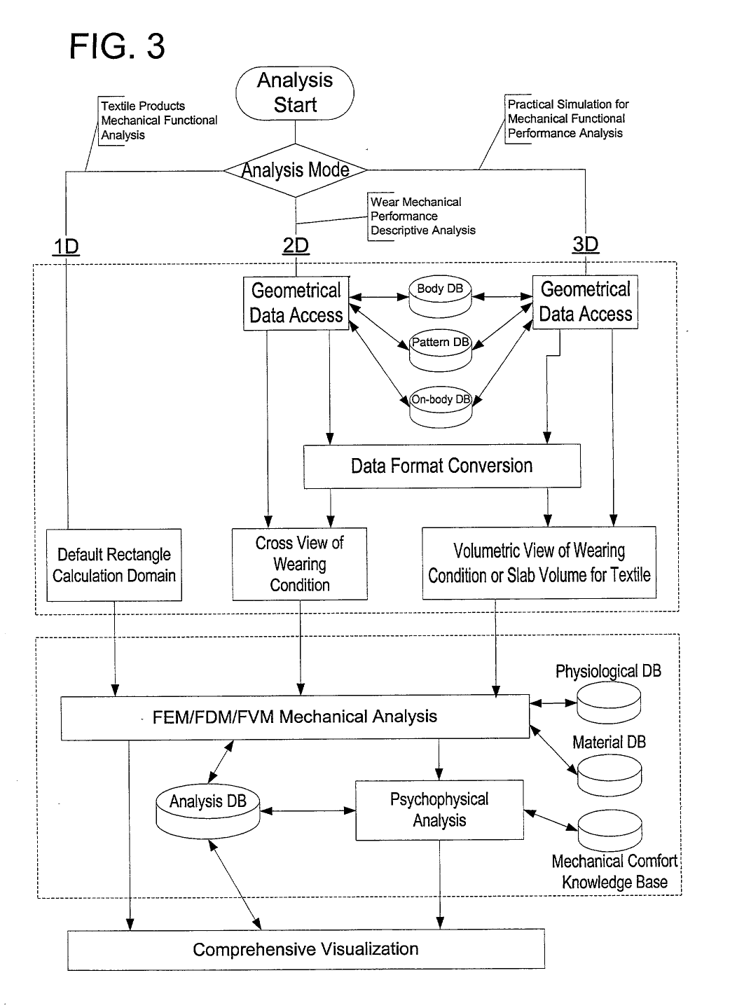

In FIG. 3, the processing chart shows three possible channels that can be used. 1D represents a single dimension, which is a consideration of “thickness” through an article of clothing, say. 2D takes into account areas of clothing and 3D represent ‘volumetric’ considerations. Thus, it is possible to consider and to create visualizations in 1D, 2D or 3D formats. Although appropriate databases are already available for supplying appropriate information for all three processing channels, comprehensive computational mathematical solutions for 3D processing are at present significantly more expensive. Thus, in practice simpler less comprehensive solutions are selected for 3D processing. In carrying out the methods of the invention, whilst a less comprehensive 3D solution may be used, for the most part more comprehensive solutions used in 1D and 2D channel processes provide sufficient or adequate aid for textile designers and engineers.

Thus, it will be apparent that methods of the invention are provided by applying computer technology to compute and visualize thermo-physiological behaviour of human body and heat-moisture transfer in textile materials based on developed databases relating thermal functional characteristic of a human body and textile articles and materials. By using appropriate established and specially developed computational mathematics with logical matching of such information, a computer is programmed to generate visual images of suitable fabrics, articles of apparel and the like for use by a textile designer or engineer when creating new items of clothing for normal or specialised application as appropriate or desired.

We claim:

1. A method of creating thermal functional designs of textiles and clothing using a computer and visual display monitor controlled by the computer, the method comprising supplying the computer with information from databases relating to thermal physiological characteristics of a human body and thermal characteristics of chosen textile materials for computational simulation of the information, and creating visual images for the monitor showing modules of thermal functional designs.

2. The method according to claim 1, in which the database of the human body comprises human model data for specific body functions, including size and shape.

3. The method according to claim 1, in which the database of the garments comprises clothing patterns data and product specification data.

4. The method according to claim 1, in which the database of the human body comprises thermal property data, including thermo-physiological and thermal comfort data of human body.

5. The method according to claim 1, in which the database of the textile materials comprises thermal property data, including fibres, yarns, fabrics and garments.
